(19) United States
(12) Patent Application Publication
(10) Pub. No.: US 2023/0281528 A1
(43) Pub. Date: Sep. 7, 2023

(54) VEHICLE DISPATCH SYSTEM AND VEHICLE DISPATCH MANAGEMENT METHOD

(71) Applicant: TOYOTA JIDOSHA KABUSHIKI KAISHA, Toyota-shi Aichi-ken (JP)

(72) Inventors: Yusuke Hayashi, Susono-shi Shizuoka-ken (JP); Taichi Kawanai, Susono-shi Shizuoka-ken (JP); Daichi Hotta, Meguro-ku Tokyo-to (JP)

(73) Assignee: TOYOTA JIDOSHA KABUSHIKI KAISHA, Toyota-shi Aichi-ken (JP)

(21) Appl. No.: 18/116,505

(22) Filed: Mar. 2, 2023

(30) Foreign Application Priority Data
Mar. 7, 2022 (JP) 2022-034680

(51) Int. Cl. G06Q 10/0631; G06Q 50/30; G06Q 10/02

(52) U.S. Cl. CPC G06Q 10/06312; G06Q 10/06315; G06Q 50/30; G06Q 10/02

(57) ABSTRACT

A system comprises a plurality of MaaS vehicles, one or more processors configured to execute generating a dispatch plan for the plurality of MaaS vehicles. The plurality of MaaS vehicles includes one or more autonomous vehicles performing autonomous driving in accordance with the dispatch plan. The generating the dispatch plan includes acquiring an operational design domain of the one or more autonomous vehicles, acquiring a prediction of dispatch service environment for a predetermined period of time in the future regarding a dispatch service area of the one or more autonomous vehicles, specifying an inoperable vehicle among the one or more autonomous vehicles based on the operational design domain and the prediction of dispatch service environment, and modifying the dispatch plan depending on vehicle information or service information of the inoperable vehicle.

### CROSS-REFERENCE TO RELATED APPLICATION

The present application claims priority under 35 U.S.C. § 119 to Japanese Patent Application No. 2022-034680, filed Mar. 7, 2022, the contents of which application are incorporated herein by reference in their entirety.

### BACKGROUND

### Technical Field

The present disclosure relates to a technique for generating a dispatch plan for vehicles. In particular, the present disclosure relates to a technique for dealing with a case where an autonomous vehicle to be dispatched does not satisfy an operational design domain.

### Background Art

Patent Literature 1 discloses an autonomous vehicle adapted for at least two different driving modes comprising a first driving mode configured for autonomous driving and a second driving mode configured for the autonomous vehicle being guided by a pilot vehicle. It is also disclosed that the second driving mode is associated to a second geographic region defined as not secured for the autonomy and that the autonomous vehicle may drive in the second driving mode in the second geographic region. In addition, there are the following Patent Literatures 2 to 6 as documents showing the technical level of the technical field according to the present disclosure.

### LIST OF RELATED ART

Patent Literature 1: Japanese Laid-Open Patent Application Publication No. JP-2019-510670

Patent Literature 2: Japanese Laid-Open Patent Application Publication No. JP-2021-163369

Patent Literature 3: Japanese Laid-Open Patent Application Publication No. JP-2021-043896

Patent Literature 4: Japanese Laid-Open Patent Application Publication No. JP-2020-106525

Patent Literature 5: International Publication No. WO2020/196084

Patent Literature 6: International Publication No. WO2020/196086

### SUMMARY

In recent years, various technologies and businesses related to operation of mobility-as-a-service (MaaS) vehicles for providing mobility services have attracted attention. In the operation of the MaaS vehicles, a dispatch plan is generally given in accordance with the contents of a service to be provided or a user's request, and the MaaS vehicles are dispatched based on the dispatch plan. Here, the MaaS vehicles may include autonomous vehicles performing autonomous driving in accordance with the dispatch plan.

By the way, for an autonomous vehicle, an operational design domain (ODD), which is a condition of environment in which autonomous driving can be continued, is defined according to a vehicle type or an autonomous driving system to be applied. When the ODD is not satisfied, the autonomous vehicle typically operates to request a driver to perform a driving operation, or to safely stop when there is no driver in the vehicle. Here, in a case where an autonomous vehicle with no driver stops and the reason why the ODD is not satisfied is a relatively long period of time, it is necessary to dispatch a person to recover the stopped autonomous vehicle.

The MaaS vehicles may have autonomous vehicles with no driver. In the operation of the MaaS vehicles, dispatching a person to recover the stopped autonomous vehicles can result in a large cost such as an influence on passengers due to the stop of the operation or an increase in labor cost due to the dispatched person. On the other hand, autonomous vehicles having a wide operational design domain are not positively adopted, because such autonomous vehicles generally have expensive sensors and system. For this reason, there is a demand for a technique for reducing the frequency of recovering and the time and labor required for recovery.

According to the technique disclosed in Patent Literature 1, the pilot vehicle can guide the autonomous vehicle from the second geographical area where the ODD is not satisfied to an area where the ODD is satisfied. In other words, if the pilot vehicle is prepared in advance, it is possible to reduce the time and effort required for recovery, and it is not necessary to dispatch a person. However, in the technique disclosed in Patent Literature 1, the second geographical area needs to be determined in advance, and it is not possible to cope with a case where the ODD is not satisfied due to a dynamic factor. In addition, it is not desirable from a cost standpoint to keep the pilot vehicle in the second geographical area.

An object of the present disclosure is, in view of the above problem, to provide a technique capable of reducing the frequency of recovering autonomous vehicles and the time and effort required for recovery.

### Means for Solving the Problem

A first disclosure is directed to a system.

The system according to the first disclosure comprises:
a plurality of MaaS vehicles;
one or more processors; and
a memory storing executable instructions that, when executed by the one or more processors, cause the one or more processors to execute generating a dispatch plan for the plurality of MaaS vehicles.
wherein the plurality of MaaS vehicles includes one or more autonomous vehicles performing autonomous driving in accordance with the dispatch plan, and
the generating the dispatch plan includes:
   acquiring an operational design domain of the one or more autonomous vehicles;
   acquiring a prediction of dispatch service environment for a predetermined period of time in the future regarding a dispatch service area of the one or more autonomous vehicles;
   specifying an inoperable vehicle among the one or more autonomous vehicles based on the operational design domain and the prediction of dispatch service environment, the inoperable vehicle being an autonomous vehicle that is predicted not to satisfy the operational design domain in the dispatch plan currently generated; and
   modifying the dispatch plan depending on vehicle information or service information of the inoperable vehicle.

A second disclosure is directed to a system further having the following features with respect to the system according to the first disclosure.

Each of the one or more autonomous vehicles is configured to:
make a stop when the operational design domain is not satisfied;
travel following a preceding vehicle, the preceding vehicle being any one of the plurality of MaaS vehicles passing by the each of the one or more autonomous vehicles after the stop; and
resume the autonomous driving when the operational design domain is satisfied while traveling following the preceding vehicle.

A third disclosure is directed to a system further having the following features with respect to the system according to the second disclosure.

The modifying the dispatch plan includes modifying the dispatch plan to let one or more pilot vehicles, as the preceding vehicle, pass through a point where it is predicted that the inoperable vehicle does not satisfy the operational design domain, the one or more pilot vehicles being selected among the plurality of MaaS vehicles.

A fourth disclosure is directed to a system further having the following features with respect to the system according to the third disclosure.

Each of the one or more pilot vehicles is an autonomous vehicle satisfying the operational design domain in the dispatch plan after modifying or a vehicle driven by a driver.

A fifth disclosure is directed to a system further having the following features with respect to the system according to the first disclosure.

The modifying the dispatch plan includes modifying the dispatch plan to replace the inoperable vehicle before dispatch with an autonomous vehicle satisfying the operational design domain in the dispatch plan or a vehicle driven by a driver.

A sixth disclosure is directed to a system further having the following features with respect to the system according to the second disclosure.

The modifying the dispatch plan includes, when there is a set of specified inoperable vehicles before dispatch predicted not to satisfy the operational design domain at the same point, modifying the dispatch plan to replace at least one of the specified inoperable vehicles before dispatch with an autonomous vehicle satisfying the operational design domain in the dispatch plan or a vehicle driven by a driver.

A seventh disclosure is directed to a method for managing dispatch service of a plurality of MaaS vehicles being dispatched in accordance with a dispatch plan, the plurality of MaaS vehicles including one or more autonomous vehicles performing autonomous driving in accordance with the dispatch plan.

The method according to the seventh disclosure comprises:
acquiring an operational design domain of the one or more autonomous vehicles;
acquiring a prediction of dispatch service environment for a predetermined period of time in the future regarding a dispatch service area of the one or more autonomous vehicles;
specifying an inoperable vehicle among the one or more autonomous vehicles based on the operational design domain and the prediction of dispatch service environment, the inoperable vehicle being an autonomous vehicle that is predicted not to satisfy the operational design domain in the dispatch plan currently generated; and
modifying the dispatch plan depending on vehicle information or service information of the inoperable vehicle.

An eighth disclosure is directed to a system further having the following features with respect to the system according to the seventh disclosure.

Each of the one or more autonomous vehicles is configured to:
make a stop when the operational design domain is not satisfied;
travel following a preceding vehicle, the preceding vehicle being any one of the plurality of MaaS vehicles passing by the each of the one or more autonomous vehicles after the stop; and
resume the autonomous driving when the operational design domain is satisfied while traveling following the preceding vehicle, and
   the modifying the dispatch plan includes modifying the dispatch plan to let one or more pilot vehicles, as the preceding vehicle, pass through a point where it is predicted that the inoperable vehicle does not satisfy the operational design domain, the one or more pilot vehicles being selected among the plurality of MaaS vehicles.

A ninth disclosure is directed to a system further having the following features with respect to the system according to the seventh disclosure.

The modifying the dispatch plan includes modifying the dispatch plan to replace the inoperable vehicle before dispatch with an autonomous vehicle satisfying the operational design domain in the dispatch plan or a vehicle driven by a driver.

A tenth disclosure is directed to a system further having the following features with respect to the system according to the seventh disclosure.

Each of the one or more autonomous vehicles is configured to:
make a stop when the operational design domain is not satisfied;
travel following a preceding vehicle, the preceding vehicle being any one of the plurality of MaaS vehicles passing by the each of the one or more autonomous vehicles after the stop; and
resume the autonomous driving when the operational design domain is satisfied while traveling following the preceding vehicle, and
   the modifying the dispatch plan includes, when there is a set of specified inoperable vehicles before dispatch predicted not to satisfy the operational design domain at the same point, modifying the dispatch plan to replace at least one of the specified inoperable vehicles before dispatch with an autonomous vehicle satisfying the operational design domain in the dispatch plan or a vehicle driven by a driver.

According to the present disclosure, an inoperable vehicle in a dispatch plan currently generated is specified based on the ODD and the prediction of dispatch service environment of one or more autonomous vehicles included in the plurality of MaaS vehicles. Then, the dispatch plan is modified depending on the vehicle information or the service information of the inoperable vehicle. As a result, it is possible to deal with the inoperable vehicle predicted not to satisfy the ODD while a predetermined period of time in the future in the current dispatch plan, and it is possible to reduce the frequency of recovering and the time and effort required for recovery. As a result, it is possible to reduce the operation cost.

### BRIEF DESCRIPTION OF DRAWINGS

FIG. 1 is a conceptual diagram for explaining an outline of a vehicle dispatch system according to the present embodiment;

FIG. 2 is a conceptual diagram for explaining an inoperable vehicle specified;

FIG. 3 is a conceptual diagram for explaining an operation when an autonomous vehicle according to the present embodiment does not satisfy an ODD;

FIG. 4 is a conceptual diagram showing an example of a modified dispatch plan by executing a dispatch plan modification processing according to the first example for the dispatch plan shown in FIG. 2;

FIG. 5 is a conceptual diagram showing an example of the dispatch plan;

FIG. 6 is a conceptual diagram showing a situation realized by a modified dispatch plan by executing a dispatch plan modification processing according to the third example;

FIG. 7 is a block diagram showing a schematic configuration of a server according to the present disclosure;

FIG. 8 is a block diagram showing a schematic configuration of a dispatch plan generation processing according to the present disclosure;

FIG. 9 is a block diagram showing a schematic configuration of an autonomous vehicle according to the present disclosure;

FIG. 10 is a block diagram showing a schematic configuration of processing executed by an autonomous driving control apparatus according to the present disclosure;

FIG. 11 is a flowchart showing an example of a processing executed by a sever according to the present disclosure;

FIG. 12 is a flowchart showing an example of a processing for generating an initial dispatch plan; and

FIG. 13 is a flowchart showing an example of a processing executed by the autonomous driving control apparatus according to the present disclosure.

### DETAILED DESCRIPTION

Hereinafter, an embodiment of the present disclosure will be described with reference to the drawings. Note that when the numerals of the numbers, the quantities, the amounts, the ranges, and the like of the respective elements are mentioned in the embodiments shown as follows, the present disclosure is not limited to the mentioned numerals unless specially explicitly described otherwise, or unless the embodiment is explicitly specified by the numerals theoretically. Furthermore, structures or the like that are described in conjunction with the following embodiment is not necessarily essential to the concept of the present disclosure unless explicitly described otherwise, or unless the present disclosure is explicitly specified by the structures or the like theoretically. Note that in the respective drawings, the same or corresponding parts are assigned with the same reference signs, and redundant explanations of the parts are properly simplified or omitted.

### 1. VEHICLE DISPATCH SYSTEM

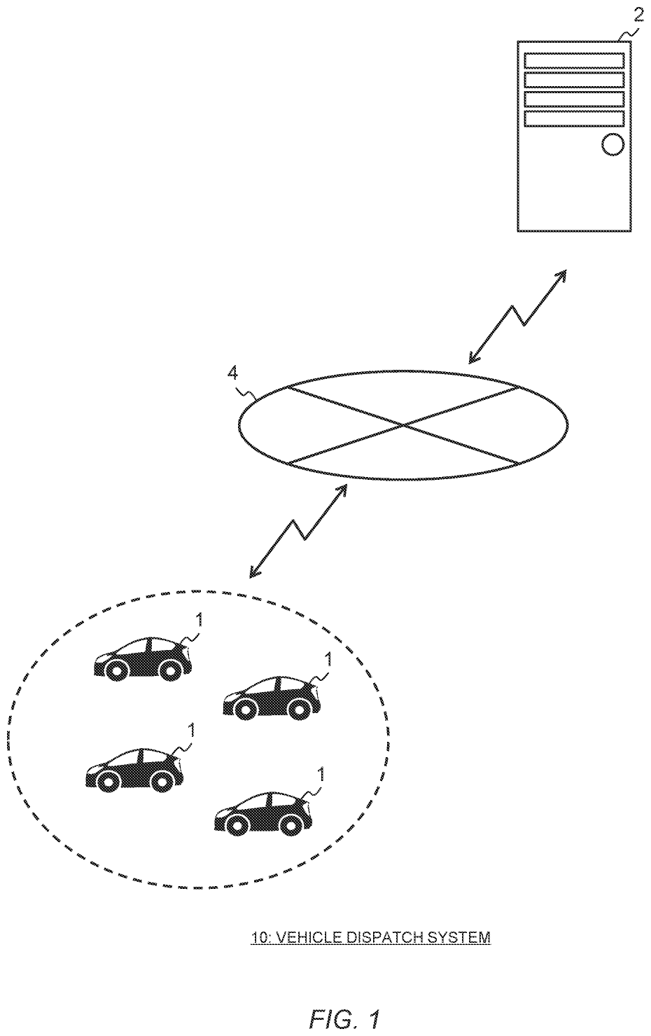

An outline of a vehicle dispatch system 10 according to the present embodiment will be described with reference to FIG. 1. In the vehicle dispatch system 10 according to the present embodiment, a dispatch plan for a plurality of MaaS vehicles 1 are generated. The dispatch plan defines a destination, a relay point, a dispatch traveling route, a dispatch time, passing or arrival time at each point, and the like for each of the plurality of MaaS vehicles 1. Each of the plurality of MaaS vehicles 1 is dispatched in accordance with the generated dispatch plan.

The plurality of MaaS vehicles 1 includes one or more autonomous vehicles performing autonomous driving in accordance with the dispatch plan. Here, the plurality of MaaS vehicles 1 may include various autonomous vehicles having different forms and specifications. For example, the plurality of MaaS vehicles 1 may include an autonomous vehicle with no driver, an autonomous vehicle capable of switching to driving by a driver, an autonomous vehicle equipped with a large number of sensors and having high detection capability of the surrounding environment, an autonomous vehicle equipped with only a minimum number of sensors and having low detection capability of the surrounding environment, and the like. The plurality of MaaS vehicles 1 may include one or more vehicles driven by a driver (hereinafter simply referred to as “manual driving vehicles”). The manual driving vehicle is driven by the driver to follow the generated dispatch plan.

Each of the plurality of MaaS vehicles 1 is dispatched from a dispatch station located at a specific point, for example. And each of the plurality of MaaS vehicles 1 may return to the dispatch station after the dispatch service is completed. Or each of the plurality of MaaS vehicles 1 may be dispatched from a predetermined parking place such as a parking lot.

In the vehicle dispatch system 10 shown in FIG. 1, a server 2 executes a processing for generating the dispatch plan (hereinafter simply referred to as “dispatch plan generation processing”). The server 2 is configured to be able to transmit/receive information to/from the plurality of MaaS vehicles 1 via a communication network 4. The communication network 4 is, for example, configured to include base stations capable of wireless communication with the plurality of MaaS vehicles 1 and the Internet. In this case, the server 2 and the base station are connected to the Internet.

The server 2 acquires vehicle information of each of the plurality of MaaS vehicles 1 via the communication network 4. Examples of the vehicle information include information regarding a vehicle type, specifications, a position, a state of vehicle body (wet, frozen, or the like), a traveling state (vehicle speed, acceleration, or the like), a surrounding environment (preceding vehicle, road surface, weather, temperature, or the like), a state of mounted sensors (presence or absence of blocking of a camera image, presence or absence of optical axis deviation, or the like), a mounting position of sensors, an autonomous driving route, and the like. In particular, the vehicle information includes information regarding an operational design domain (ODD) of one or more autonomous vehicles (hereinafter simply referred to as “autonomous vehicles”) included in the plurality of MaaS vehicles 1. Examples of the ODD include brightness at which autonomous driving can be continued, a state of a road surface at which autonomous driving can be continued, a weather state at which autonomous driving can be continued, detection accuracy of a sensor at which autonomous driving can be continued, a road shape at which autonomous driving can be continued, a type of a surrounding obstacle at which autonomous driving can be continued, and the like.

The server 2 executes the dispatch plan generation processing based on the acquired information, and the server 2 transmits the dispatch plan to the plurality of MaaS vehicles 1 via the communication network 4. In this sense, the server 2 can also be referred to as a “dispatch management device”.

By the way, generally, an autonomous vehicle with no driver is configured to make a stop safely when the ODD is not satisfied. In this case, when the reason why the ODD is not satisfied is a relatively long period of time, it is necessary to recover the autonomous vehicle. Examples of cases where it is necessary to recover the autonomous vehicle include a case where the ODD is not satisfied due to a heavy rain caused by weather changes during the operation, a case where the ODD is not satisfied due to dark by the sun set during the operation, a case where the ODD is not satisfied due to a narrow road width caused by a construction or the appearance of a fallen object, a case where the ODD is not satisfied due to detecting that the autonomous vehicle has strayed from a motorway (e.g., detecting a pedestrian or a bicycle), and the like.

Dispatching persons to recover the autonomous vehicles can result in a large cost such as an influence on passengers due to stop of the operation and an increase in labor cost. For this reason, it is desirable to reduce the frequency of recovering and the time and labor required for recovery.

In the vehicle dispatch system 10 according to the present embodiment, the server 2 acquires a prediction of dispatch service environment for a predetermined period of time in the future regarding a dispatch service area of the autonomous vehicles. The prediction of dispatch service environment may include current dispatch service environment. And in the dispatch plan generation processing, the server 2 executes specifying an inoperable vehicle among the autonomous vehicles based on the ODD and the prediction of dispatch service environment of the autonomous vehicles, the inoperable vehicle being an autonomous vehicle that is predicted not to satisfy the ODD in the dispatch plan currently generated.

The dispatch service area of the autonomous vehicles is, for example, an area in which the autonomous vehicles are scheduled to dispatch. The dispatch service area may be a specific area given in advance, or may be an area given in accordance with the dispatch traveling route defined in the dispatch plan (for example, an area including the entire dispatch traveling route).

The dispatch service environment is environment related to the dispatch service by the plurality of MaaS vehicles 1. In particular, the dispatch service environment includes environment information related to the ODD of the autonomous vehicles. Examples of the dispatch service environment include road traffic information (e.g., information for a road shape, a state of road condition, a stopped accident vehicle, and the like), sunshine information, weather information, information about occurrences of special situations (e.g., appearance of a fallen object or a dark place, and the like), and the like. The server 2 may be configured to acquire the dispatch service environment at each time during the predetermined period of time in the future. Furthermore, the server 2 may be configured to acquire the dispatch service environment from other devices (not illustrated in FIG. 1) via the communication network 4. For example, the server 2 may be configured to acquire the dispatch service environment by communicating with another server transmitting road traffic information or an another server transmitting weather information.

The server 2 is further configured to acquire service information. The service information is information related to the dispatch service according to the dispatch plan. Examples of the service information include information regarding the dispatch traveling route defined by the dispatch plan, a passing time at each point of the dispatch traveling route, and the like. The server 2 may be configured to acquire the service information from the autonomous vehicles via the communication network 4 or to acquire the service information by referring to the current dispatch plan.

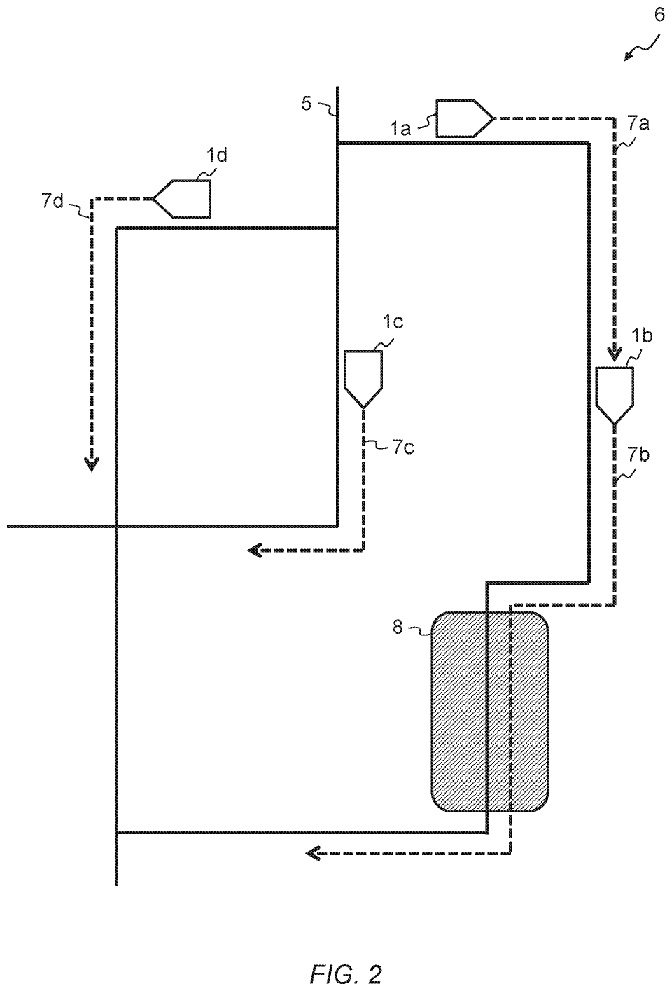

The inoperable vehicle specified in the dispatch plan generation processing will be described with reference to FIG. 2. FIG. 2 conceptually illustrates an example of the dispatch plan at a certain time in a dispatch service area 6 including roads 5. FIG. 2 shows dispatch traveling routes 7a, 7b, 7c, and 7d of four MaaS vehicles (1a, 1b, 1c, and 1d) defined by the dispatch plan.

It is assumed that each of the four MaaS vehicles is an autonomous vehicle. That is, each of the four MaaS vehicles autonomously travel in accordance with the dispatch traveling route defined by the dispatch plan. In addition, it is assumed that a situation in which the ODD is not satisfied is predicted to occur at a point 8 illustrated in FIG. 2 by the prediction of dispatch service environment. In this case, the autonomous vehicles 1a and 1b are specified as the inoperable vehicles, because the dispatch traveling route includes the point 8. However, if it is predicted that the situation in which the ODD is not satisfied will occur at the point 8 after the autonomous vehicle 1a or 1b path through the point 8, the autonomous vehicle 1a or 1b may not be specified as the inoperable vehicle.

Here, examples of the predicting of occurrence of a situation in which the ODD of the autonomous vehicles is not satisfied include: Predicting a point where heavy rain will occur from weather forecast at each time acquired as the prediction of dispatch service environment; Predicting timing when night falls during the operation from estimated time of sunset acquired as the prediction of dispatch service environment; Predicting a point where shadows occur from information of buildings in the dispatch service area 6 and direction of the sun at each hour acquired as the prediction of dispatch service environment; Predicting a point where steam (by exhaust gas or gas from manholes) or fog is generated from humidity and temperature at each time acquired as the prediction of dispatch service environment; Predicting appearance of a fallen object, a pedestrian, and a bicycle by detection information of sensors installed in vehicles traveling in the dispatch service area 6.

Predicted that the ODD is not satisfied may be performed for each of the autonomous vehicles. For example, in FIG. 2, it is assumed that heavy rain is predicted to occur at the point 8 from the prediction of the dispatch service environment. In addition, it is assumed that the autonomous vehicle 1a satisfies the ODD even when heavy rain, and the autonomous vehicle 1b does not satisfy the ODD when heavy rain. In this case, while the autonomous vehicle 1b is specified as the inoperable vehicle, the autonomous vehicle 1a is not specified as the inoperable vehicle.

As described above, in the vehicle dispatch system 10 according to the present embodiment, the inoperable vehicle is specified in the current dispatch plan based on the ODD and the prediction of dispatch service environment of the autonomous vehicles.

Then in the vehicle dispatch system 10 according to the present embodiment, in the dispatch plan generation processing, the server 2 executes a processing (hereinafter referred to as a “dispatch plan modification processing”) for modifying the dispatch plan depending on the vehicle information or the service information of the inoperable vehicle. By executing the dispatch plan modification processing, it is possible to deal with the inoperable vehicle predicted not to satisfy the ODD while the predetermined period of time in the future in the current dispatch plan, and it is possible to reduce the frequency of recovering and the time and effort required for recovery. The following will describe several examples of the modified dispatch plan realized by executing the dispatch plan modification processing.

### 1-1. First Example

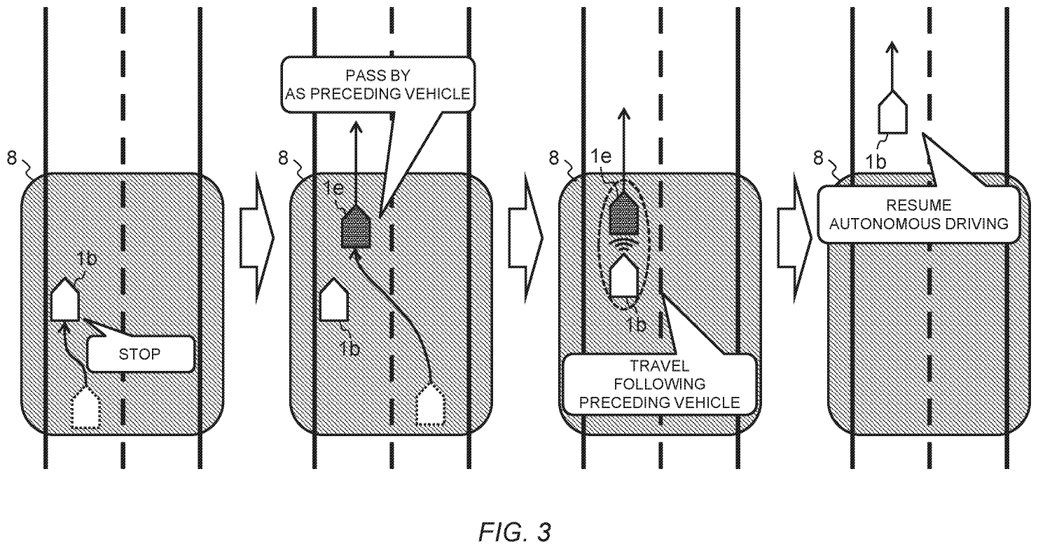

In the first example, each of the autonomous vehicles is configured to operate as follows when the ODD is not satisfied. First, an operation when the autonomous vehicles according to the first example do not satisfy the ODD will be described with reference to FIG. 3. FIG. 3 shows a situation in which the autonomous vehicle 1b reaches a point 8 where the ODD is no longer satisfied. That is the autonomous vehicle 1b is specified as the inoperable vehicle. At this time, first, the autonomous vehicle 1b operates to make a stop. For example, the autonomous vehicle 1b stops on the shoulder of the road while checking traveling states of surrounding vehicles. After the stop, the autonomous vehicle 1b travel following a preceding vehicle, the preceding vehicle being any one of the plurality of MaaS vehicles 1 passing by the autonomous vehicle 1b. FIG. 3 shows a situation in which a MaaS vehicle 1e passes by the autonomous vehicle 1b as the preceding vehicle and the autonomous vehicle 1b follows the MaaS vehicle 1e. Then, the autonomous vehicle 1b resumes the autonomous driving when the ODD is satisfied while traveling following the preceding vehicle. FIG. 3 shows a situation in which the autonomous vehicle 1b resumes the autonomous driving when the autonomous vehicle 1b leaves the point 8 while traveling following the MaaS vehicle 1e.

With the configuration of the autonomous vehicles as described above, even if the autonomous vehicles stop because the ODD is not satisfied, the autonomous vehicles can get out from the situation in which the ODD is not satisfied by traveling following the preceding vehicle. In this sense, the MaaS vehicle (the MaaS vehicle 1e shown in FIG. 3) passing by the inoperable vehicle (the autonomous vehicles 1b shown in FIG. 3) as the preceding vehicle can be referred as “pilot vehicle”.

In the first example, in the dispatch plan modification processing, the server 2 executes, depending on the vehicle information or the service information of the inoperable vehicle, selecting the one or more pilot vehicles from the plurality of MaaS vehicles 1. And the server 2 executes modifying the dispatch plan to let the one or more pilot vehicles, as the preceding vehicle, pass through a point where it is predicted that the inoperable vehicle does not satisfy the ODD.

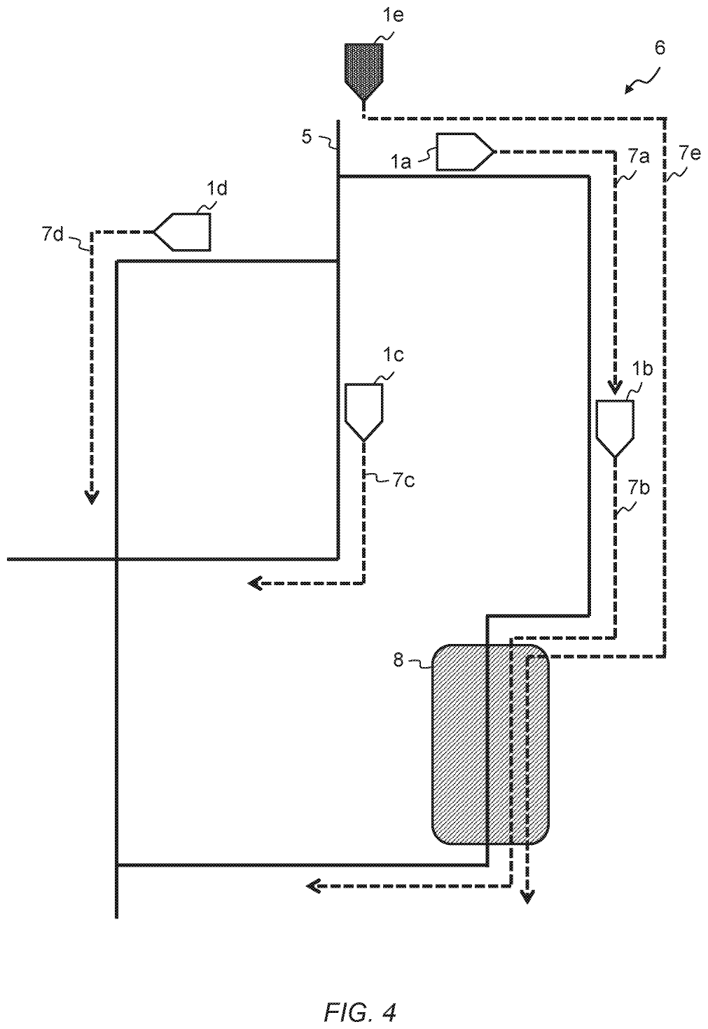

FIG. 4 is a conceptual diagram showing an example of a modified dispatch plan by executing the dispatch plan modification processing according to the first example for the dispatch plan shown in FIG. 2. In FIG. 4, it is assumed that the autonomous vehicles 1a and 1b are specified as the inoperable vehicles predicted not to satisfy the ODD at the point 8. As shown in FIG. 4, in the modified dispatch plan, the MaaS vehicle 1e having a dispatch traveling route 7e passing through the point 8 is newly dispatched.

The MaaS vehicle 1e is selected from the plurality of MaaS vehicle 1 satisfying the ODD in the dispatch traveling route 7e passing through the point 8. For example, when the autonomous vehicles 1a and 1b are specified as the inoperable vehicles because it is predicted that heavy rain will occur at the point 8, the server 2 selects the MaaS vehicle 1e from the autonomous vehicles satisfying the ODD even when heavy rain. Alternatively, the server 2 selects, as the MaaS vehicle 1e, a manual driving vehicle. Examples of the autonomous vehicles satisfying the ODD even when heavy rain include an autonomous vehicle with additional cameras, an autonomous vehicle equipped with a plurality of LiDARs (capable of detecting the influence of rain from reflection characteristics) emitting laser beams having different wavelengths.

For the other difficult situations, the MaaS vehicle 1e is suitably selected as follows. Examples of the autonomous vehicles satisfying the ODD even in a situation where a dark place appears include an autonomous vehicle with a LiDAR or a night vision camera. Examples of the autonomous vehicles satisfying the ODD even in a situation where a fallen object appears include an autonomous vehicle with a LiDAR emitting lasers obliquely downward, a LiDAR disposed at a low position of the vehicle, or a high-density LiDAR. Examples of the autonomous vehicles satisfying the ODD even in a situation where a pedestrian or a bicycle is detected include an autonomous vehicle with a high-density LiDAR or a thermography. However, the manual driving vehicle may be selected as the MaaS vehicle 1e for the situations described above.

These autonomous vehicles satisfying the ODD even in the difficult situations can be prepared as the plurality of MaaS vehicles 1 depending on possible situations assumed in the dispatch service area 6 when the dispatch system 10 according to the present embodiment is applied. In particular, it is possible to prepare a necessary and sufficient amount in consideration of the balance with the cost.

Furthermore, by the prediction of dispatch service environment for points other than the point 8 on the dispatch traveling route 7e, the MaaS vehicle 1e is selected to satisfy the ODD while traveling on the dispatch traveling route 7e. Note that, the dispatch traveling route 7e may no be the same as the dispatch traveling route 7a or 7b. That is, the dispatch traveling route 7e need only include at least the point 8.

In addition, the modified dispatch plan defines the dispatch traveling route 7e to let the MaaS vehicle 1e, as the preceding vehicle, pass by the autonomous vehicles 1a and 1b at the point 8. That is, in the dispatch traveling route 7e defined by the modified dispatch plan, the time when the MaaS car 1e passes through the point 8 is later than the time when the autonomous vehicles 1a and 1b are scheduled to pass through the point 8. The modifying the dispatch plan like this can be performed by acquiring the scheduled time when the autonomous vehicles 1a and 1b pass through the point 8 as the vehicle information or the service information of the autonomous vehicles 1a and 1b. Furthermore, in order to shorten the stopping time of the autonomous vehicles 1a and 1b, the modified dispatch plan may define the traveling route 7e to let the MaaS vehicle 1e pass through the point 8 immediately after the scheduled time when the autonomous vehicles 1a and 1b pass through the point 8.

In this way, by modifying the dispatch plan to dispatch the MaaS vehicle 1e, the autonomous vehicles 1a and 1b can travel following the MaaS vehicle 1e at the point 8. Then, the autonomous vehicles 1a and 1b can resume autonomous driving when leaving the point 8 while traveling following the MaaS vehicle 1e. By the way, it is conceivable that a case where two or more inoperable vehicles each expected not to satisfy the ODD at different points are specified, or a case where two or more inoperable vehicles each expected not to satisfy the ODD at different time points. In such cases, the dispatch plan may be modified to dispatch two or more pilot vehicles according to the vehicle information or the service information of the two or more inoperable vehicles. In particular, the dispatch plan may be modified to dispatch the two or more pilot vehicles efficiently. For example, the dispatch plan may be modified to let one pilot vehicle pass by multiple inoperable vehicles.

As described above, according to the first example, the dispatch plan is modified to let the one or more pilot vehicles, as the preceding vehicle, pass through a point where it is predicted that the inoperable vehicle does not satisfy the ODD. As a result, even when the ODD is no longer satisfied, the inoperable vehicle can leave the point where the ODD is not satisfied by traveling following the one or more pilot vehicles. Then, the inoperable vehicle can resume autonomous driving. It is thus possible to reduce the frequency of recovering the autonomous vehicles and the time and effort required for recovering the autonomous vehicles. In particular, the dispatching the one or more pilot vehicles can be realized in a necessary and sufficient manner depending on the specified inoperable vehicles. Therefore, the dispatching the one or more pilot vehicles can be realized at low cost.

### 1-2. Second Example

In the second example, in the dispatch plan modification processing, the server 2 executes, depending on the vehicle information or the service information of the inoperable vehicle, modifying the dispatch plan to replace the inoperable vehicle before dispatch with an autonomous vehicle satisfying the ODD or a manual driving vehicle.

For example, it is assumed that the current dispatch plan is the dispatch plan shown in FIG. 2, and the autonomous vehicles 1a, 1b, 1c, and 1d have not yet been dispatched. In addition, it is assumed that the autonomous vehicles 1a and 1b are specified as the inoperable vehicles predicted not to satisfy the ODD at the point 8. In this case, according to the second example, the server 2 modifies the dispatch plan to replace each of the autonomous vehicles 1a and 1b with a manual driving vehicle or an autonomous vehicle satisfying the ODD at the point 8.

For example, when the autonomous vehicles 1a and 1b are specified as inoperable vehicles because it is predicted that a dark place will appear at the point 8, the server 2 modifies the dispatch plan to replace each of the autonomous vehicles 1a and 1b with a manual driving vehicle or an autonomous vehicle satisfying the ODD even in a situation where the dark place appears. Also, for example, when the autonomous vehicles 1a and 1b are specified as inoperable vehicles because it is predicted that heavy rain will occur at the point 8, the server 2 modifies the dispatch plan to replace each of the autonomous vehicles 1a and 1b with a manual driving vehicle or an autonomous vehicle satisfying the ODD even when heavy rain.

By modifying the dispatch plan in this way, the dispatch service by the specified inoperable vehicle predicted not to satisfy the ODD before dispatch can be achieved by the manual driving vehicle or the MaaS vehicle satisfying the ODD. It is thus possible to reduce the frequency of recovering the autonomous vehicles and the time and effort required for recovering the autonomous vehicles.

It is possible to combine the first example and the second example. For example, the server 2 may be configured to modify the dispatch plan according to the first example for inoperable vehicles after dispatch, and modify the dispatch plan according to the second example for inoperable vehicles before dispatch.

### 1-3. Third Example

In the third example, each of the autonomous vehicles is configured to operate similarly as described in the first example (see FIG. 3) when the ODD is not satisfied.

In the third example, in the dispatch plan modification processing, the server 2 executes, when there is a set of specified inoperable vehicles before dispatch predicted not to satisfy the ODD at the same point, modifying the dispatch plan to replace at least one of the specified inoperable vehicles with an autonomous vehicle satisfying the ODD in the dispatch plan or a manual driving vehicle.

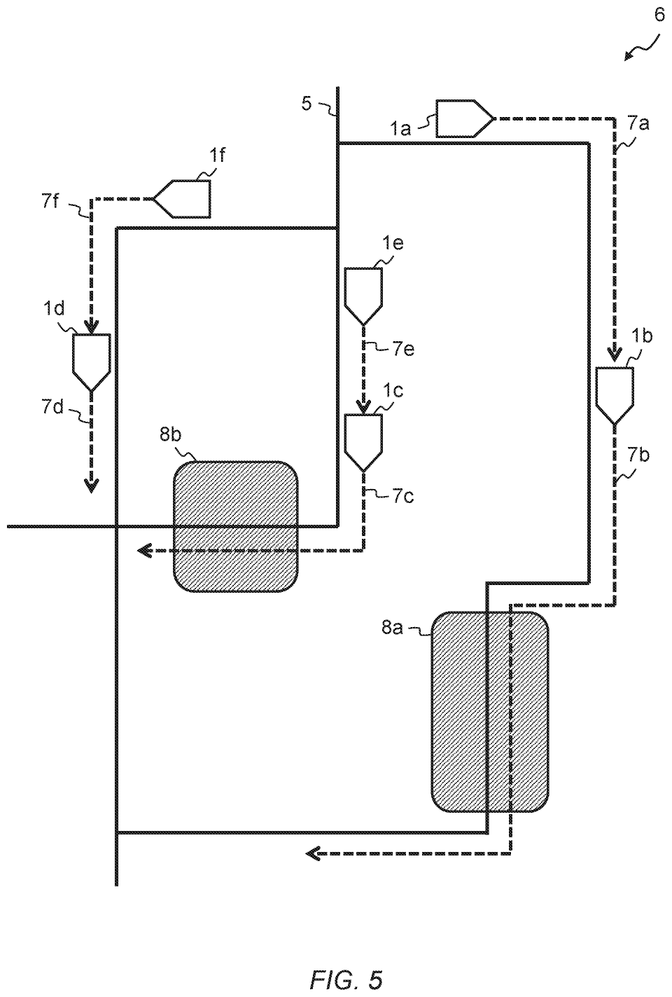

Hereinafter, the third example will be described with reference to FIG. 5. FIG. 5 is a conceptual diagram showing an example of the dispatch plan. It is assumed that the autonomous vehicles 1a, 1b, 1c, 1d, 1e, and 1f have not yet been dispatched in the dispatch plan before modifying. In addition, by the prediction of dispatch service environment, it is assumed that a situation in which the autonomous vehicles 1a and 1b do not satisfy the ODD is predicted to occur at a point 8a, and it is assumed that a situation in which the autonomous vehicle 1c and the 1e do not satisfy the ODD is predicted to occur at a point 8b. That is, in the dispatch plan before modifying shown in FIG. 5, the autonomous vehicles 1a, 1b, 1c, and 1e are specified as the inoperable vehicles. And then, in the dispatch plan before modifying shown in FIG. 5, there are two sets of the specified inoperable vehicles before dispatch predicted not to satisfy the ODD at the same point. The one is a set of the autonomous vehicles 1a and 1b each of which predicted not to satisfy the ODD at the point 8a. And another one is a set of the autonomous vehicles 1c and 1e each of which predicted not to satisfy the ODD at the point 8b.

In this case, according to the third example, the server 2 executes modifying the dispatch plan to replace at least one of the autonomous vehicles 1a and 1b with an autonomous vehicle satisfying the ODD at the point 8a or a manual driving vehicle. And the server 2 executes modifying the dispatch plan to replace at least one of the autonomous vehicles 1c and 1e with an autonomous vehicle satisfying the ODD at the point 8b or a manual driving vehicle.

By modifying the dispatch plan in this way, the dispatch service by the specified inoperable vehicles to be replaced can be achieved by the autonomous vehicle satisfying the ODD or the manual driving vehicle. Furthermore, the specified inoperable vehicles not to be replaced can leave a point where the ODD is not satisfied by traveling following the autonomous vehicle satisfying the ODD or the manual driving vehicle. And then, the specified inoperable vehicles not to be replaced can resume autonomous driving It is thus possible to reduce the frequency of recovering the autonomous vehicles and the time and effort required for recovering the autonomous vehicles.

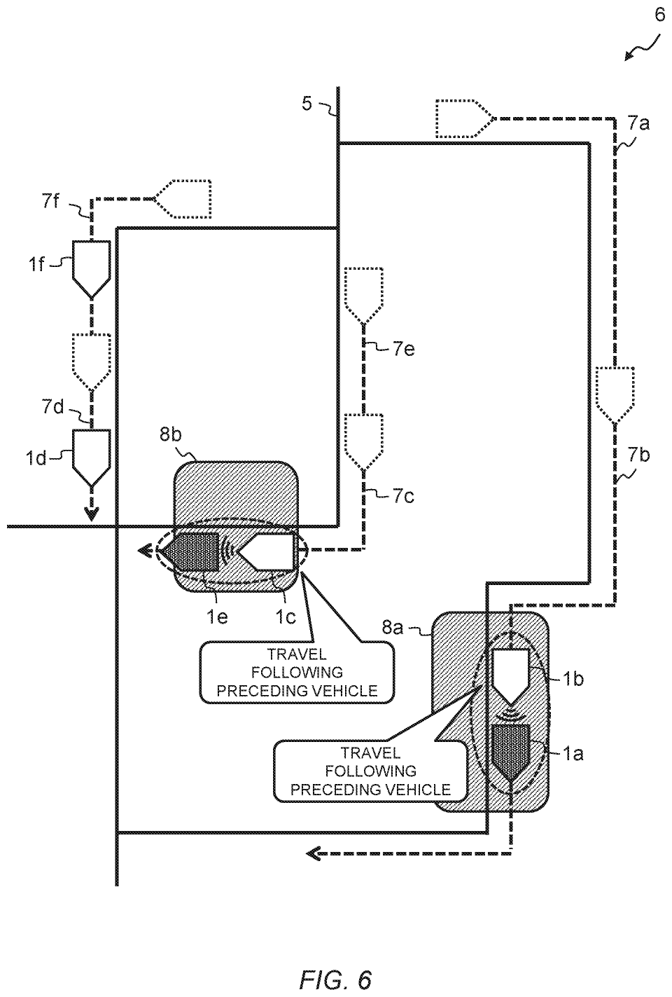

FIG. 6 shows a situation realized by the modified dispatch plan according to the third example. Here, in the dispatch plan modification processing, the server 2 executes modifying the dispatch plan shown in FIG. 5 to replace the autonomous vehicles 1a and 1e as described. As shown in FIG. 6, by modifying the dispatch plan according to the third example, it is understood that the autonomous vehicle 1b can leave the point 8a by travelling following the autonomous vehicle 1a. And the autonomous vehicle 1c can leave the point 8b by travelling following the autonomous vehicle 1e. Furthermore, the autonomous vehicles 1a, 1d, 1e, and if can also satisfy the ODD in the modified dispatch plan.

Note that it can also be assumed that different situations are predicted to occur at each point where it is predicted that the ODD will not be satisfied. For example, in FIG. 5, heavy rain is predicted to occur at the point 8a while appearance of a dark place is predicted to occur at the point 8b. As another example, a situation in which neither autonomous vehicle can satisfy the ODD is predicted to occur at the point 8a while a situation in which an autonomous vehicle with high specifications can satisfy the ODD is predicted to occur. In such cases, for each set of the specified inoperable vehicles, the server 2 may execute replacing the specified inoperable vehicles depending on the situation of each point where it predicted that the ODD will not be satisfied. in accordance with the server 2 may select the MaaS vehicles 1 to be replaced may be selected for each set of inoperable vehicles in accordance with the situation of each point at which it is predicted that the ODD will not be satisfied. In particular, the server 2 may be configured to replace the specified inoperable vehicles as necessary and sufficient for cost considerations.

A combination of the first example and the third example is also possible. For example, the server 2 may be configured to modify the dispatch plan according to the first example for inoperable vehicles after dispatch, and modify the dispatch plan according to the third example for inoperable vehicles before dispatch.

### 2. CONFIGURATION

Hereinafter, a schematic configuration of the server 2 (dispatch management device) and the autonomous vehicle in the vehicle dispatch system 10 according to the present embodiment will be described.

### 2-1. Configuration Of Server (Dispatch Management Device)

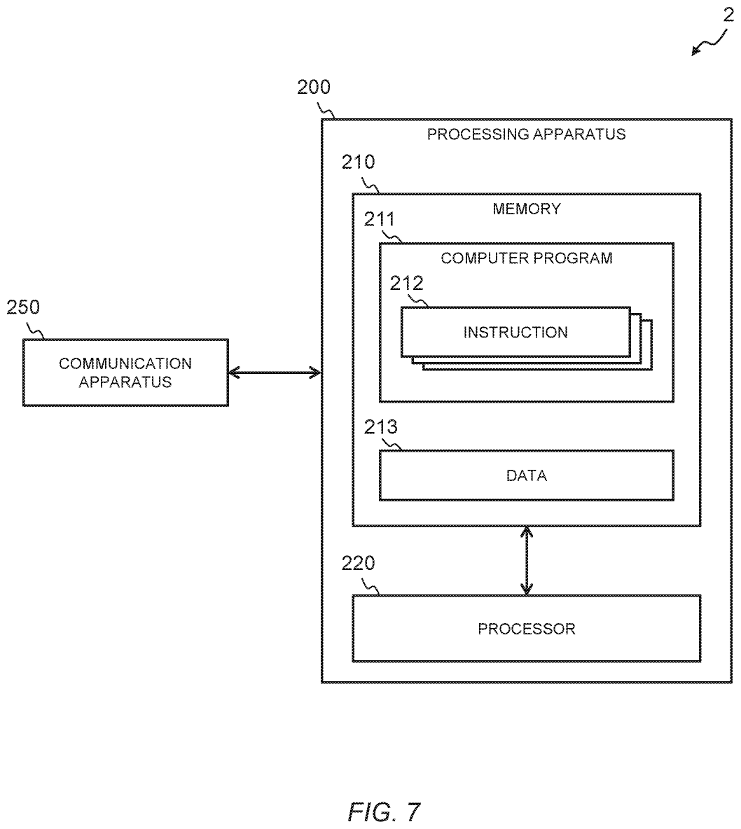

FIG. 7 is a block diagram showing a schematic configuration of the server 2 (dispatch management device). The server 2 includes a processing apparatus 200 and a communication apparatus 250. The processing apparatus 200 is configured to be able to transmit/receive information to/from the communication apparatus 250. For example, these are connected by electrical cables, optical lines, or the like.

The processing apparatus 200 is a computer including one or more memories 210 (hereinafter simply referred to as “memory 210”) and one or more processors 220 (hereinafter simply referred to as “processor 220”). The memory 210 is coupled to the processor 220 and stores executable instructions 212 and various data 213 required for performing processing. The instructions 212 are provided by a computer program 211. In this sense, the memory 210 may also be referred to as “program memory”.

The instructions 212, when executed by the processor 220, cause the processor 220 to execute various processing based on the data 213. In particular, the instructions 212 are configured to cause the processor 220 execute the dispatch plan generation processing. Then, the processing apparatus 200 transmits the dispatch plan generated by executing the dispatch plan generation processing to the communication apparatus 250.

The communication apparatus 250 transmits and receives various kinds of information by communicating with a device outside the server 2. That is, the communication apparatus 250 is a device for performing communication via the communication network 4. In particular, the communication apparatus 250 transmits the dispatch plan acquired from the processing apparatus 200 to the plurality of MaaS vehicles 1. And the communication apparatus 250 transmits received information to the processing apparatus 200. Examples of the received information include the vehicle information (e.g., information of the ODD) of the plurality of MaaS vehicles 1 and the prediction of dispatch service environment regarding a dispatch service area of the plurality of MaaS vehicles 1. The processing apparatus 200 stores, as the data 213, information acquired from the communication apparatus 250 in the memory 210.

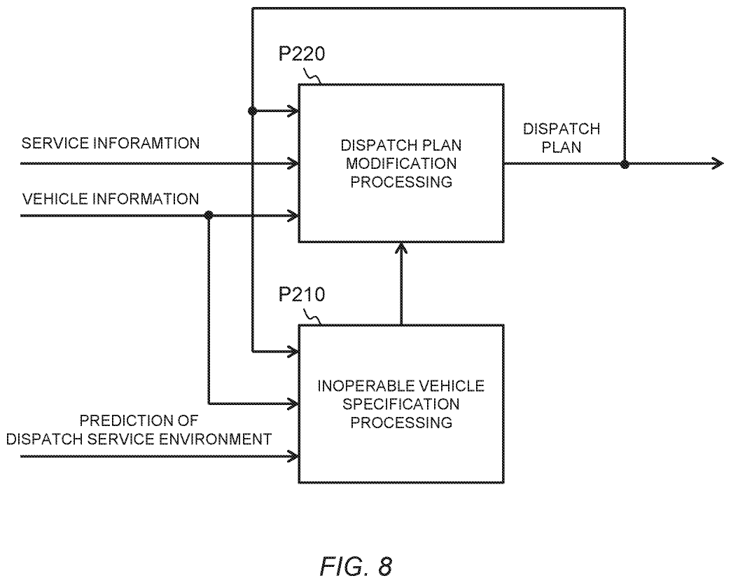

Next, a schematic configuration of the dispatch plan generation processing will be described with reference to FIG. 8. The dispatch plan generation processing includes an inoperable vehicle specification processing P210 and a dispatch plan modification processing P220.

In the inoperable vehicle specifying process P210, the processor 220 executes specifying the inoperable vehicle in the dispatch plan currently generated based on the ODD and the prediction of dispatch service environment of each of the plurality of MaaS vehicles 1. That is, the inoperable vehicle in the current dispatch plan is given as the processing result of the inoperable vehicle specification processing P210. The processing result of the inoperable vehicle specification processing P210 may be ID information individually given to each of the plurality of MaaS vehicles 1, for example. Further, the processing result of the inoperable vehicle specification processing P210 may include information for a point and a time at which the ODD is not satisfied for the specified inoperable vehicle.

In the dispatch plan modification processing P220, the processor 220 executes modifying the dispatch plan depending on the vehicle information or the service information of the inoperable vehicle specified by the inoperable vehicle specification processing P210. For example, the processor 220 modifies the dispatch plan according to the above-described first example, second example, third example, or a combination thereof. Then, the modified dispatch plan is given as a processing result of the dispatch plan generation processing.

When executing the dispatch plan generation processing for the plurality of MaaS vehicles 1 for the first time, the processor 220 first generates a initial dispatch plan as an initial value in the dispatch plan modification processing P220. Processing related to generation of the initial dispatch plan will be described later.

### 2-2. Configuration Of Autonomous Vehicle

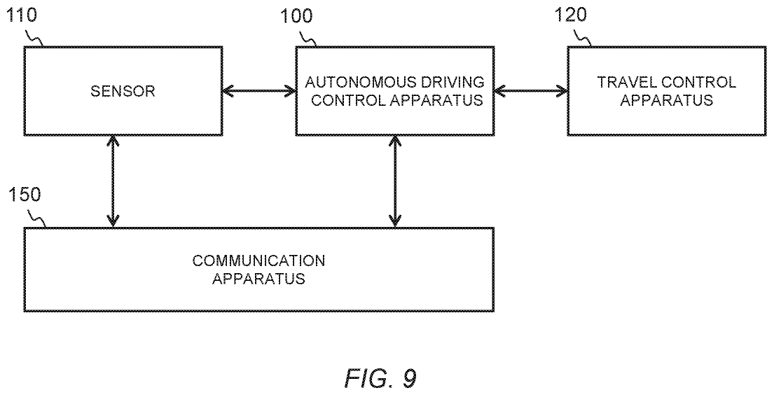

FIG. 9 is a block diagram showing a schematic configuration of each of the autonomous vehicles included in the plurality of MaaS vehicles 1. The autonomous vehicle includes an autonomous driving control apparatus 100, a sensor 110, a travel control apparatus 120, and a communication apparatus 150. The autonomous driving control apparatus 100 is configured to be able to transmit/receive information to/from the sensor 110, the travel control apparatus 120, and the communication apparatus 150. Typically, they are electrically connected by cable harnesses. As other configurations, they may be connected by wireless communication, an optical communication line, and the like. Furthermore, the communication apparatus 150 is configured to be able to transmit/receive information to/from the sensor 110.

The sensor 110 detects information related to driving environment of the autonomous vehicle and outputs the detected information. The detected information output by the sensor 110 is transmitted to the autonomous driving control apparatus 100 and the communication apparatus 150. The sensor 110 typically includes a surrounding environment detection sensor detecting information related to surrounding environment (a preceding vehicle, a white line, an obstacle, or the like) of the autonomous vehicle and a traveling state detection sensor detecting information related to a traveling state (a vehicle speed, an acceleration, a yaw rate, or the like) of the autonomous vehicle. Examples of the surrounding environment detection sensor include a camera, a millimeter-wave radar, a LiDAR, and the like. Examples of the traveling state detection sensor include a wheel speed sensor, a G sensor, a gyro sensor, and the like. In addition, the sensor 110 may include a GPS receiver acquiring a position by GPS.

Each of the autonomous vehicles included in the plurality of MaaS vehicles 1 may include a different sensor 110 depending on the specifications thereof. For example, each of the autonomous vehicles may appropriately include a night vision camera, a thermography, a high-density LiDAR, or the like, depending on the specifications thereof.

The autonomous driving control apparatus 100 executes processing regarding autonomous driving and outputs a control signal based on the acquired information. The autonomous driving control apparatus 100 acquires at least a dispatch plan generated in the server 2 from the communication apparatus 150 and executes processing for performing the autonomous driving in accordance with the acquired dispatch plan. The control signal output by the autonomous driving control apparatus 100 is transmitted to the travel control apparatus 120. The autonomous driving control apparatus 100 may be configured to output the service information and information of a state of control to the communication apparatus 150 along with the execution of the processing regarding the autonomous driving. The autonomous driving control apparatus 100 is typically implemented by one or more electronic control units (ECUs).

The communication apparatus 150 transmits/receives various kinds of information by communicating with a device outside the autonomous vehicle. The communication apparatus 150 at least communicates with the server 2 via the communication network 4 and receives the dispatch plan generated in the server 2. Further, the communication apparatus 150 may be configured to communicate with the server 2 or other MaaS vehicles in the vicinity and receive the service information of the other MaaS vehicles. By configuring the communication apparatus 150 like this, it is possible to detect that any one of the plurality of MaaS vehicles 1 approaches and passes by as the preceding vehicle. The communication apparatus 150 transmits at least information of the ODD of the autonomous vehicle to the server 2. Other examples of information received by the communication apparatus 150 include map information, road traffic information, and the like. Examples of information transmitted by the communication apparatus 150 include the vehicle information and the service information.

The travel control apparatus 120 executes processing regarding travel control. In particular, the travel control apparatus 120 executes processing for controlling the autonomous vehicle to travel in accordance with the control signal acquired from the autonomous driving control apparatus 100. As a result, performing the autonomous driving by the autonomous vehicle is realized. The travel control apparatus 120 is realized by, for example, one or more ECUs controlling operations of a group of actuators included in the autonomous vehicle. Examples of the group of actuators include an actuator that drives a power unit (an internal combustion engine, an electric motor, or the like), an actuator that drives a brake mechanism, an actuator that drives a steering mechanism, and the like.

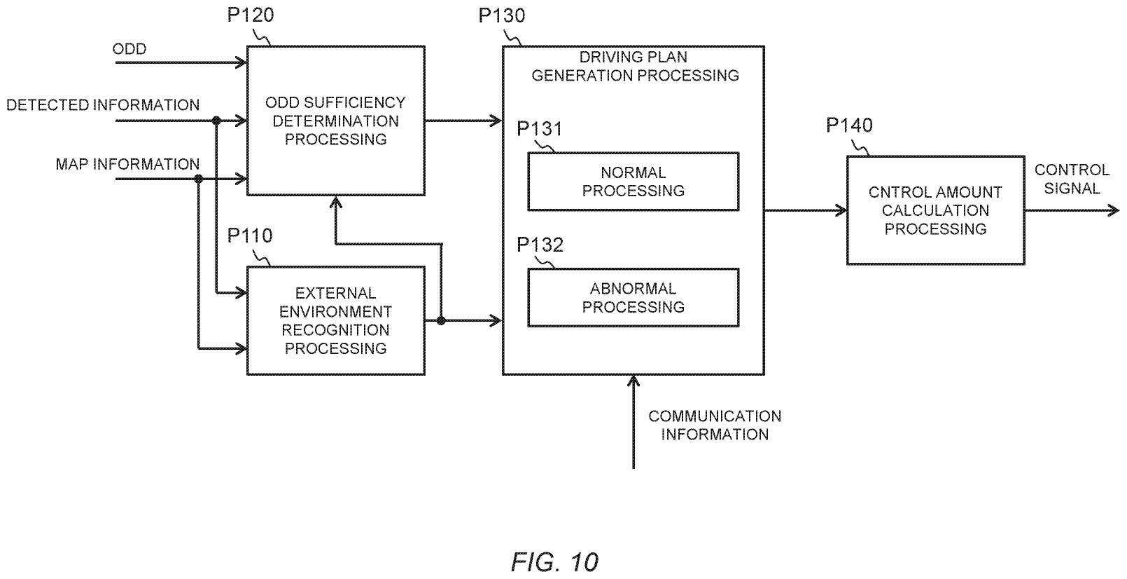

Next, a schematic configuration of a processing executed by the autonomous driving control apparatus 100 will be described with reference to FIG. 10. The processing executed by the autonomous driving control apparatus 100 include an external environment recognition processing P110, an ODD sufficiency determination processing P120, a driving plan generation processing P130, and a control amount calculation processing P140.

In the external environment recognition processing P110, the autonomous driving control apparatus 100 executes recognizing external environment of the autonomous vehicle based on the detected information by the sensor 110 and the map information. For example, in the external environment recognition processing P110, the autonomous driving control apparatus 100 executes a processing for localization, integration of the detection information and localization result with the map information, and the like. The external environment recognition processing P110 may employ a suitable known technique.

In the ODD sufficiency determination processing P120, the autonomous driving control apparatus 100 executes determining whether or not the ODD is satisfied based on the detected information by the sensor 110 and the map information. Furthermore, the autonomous driving control apparatus 100 may be configured to execute determining whether or not the ODD is satisfied based on the processing result of the external environment recognition processing P110 as well.

In the driving plan generation processing P130, the autonomous driving control apparatus 100 executes generating a driving plan based on the processing result of the external environment recognition processing P110. The driving plan includes, for example, information regarding determinations of a driving operation, a traveling route, and the like. In particular, the autonomous driving control apparatus 100 executes either a normal processing P131 or an abnormal processing P131 in accordance with the processing result of the ODD sufficiency determination processing P120. The autonomous driving control apparatus 100 executes the normal processing P131 when the processing result of the ODD sufficiency determination processing P120 shows that the ODD is satisfied. In the normal processing P131, the autonomous driving control apparatus 100 executes a processing for continuing the autonomous driving in accordance with the dispatch plan. On the other hand, the autonomous driving control apparatus 100 executes the abnormal processing P132 when the processing result of the ODD sufficiency determination processing P120 shows that the ODD is not satisfied. In the abnormal processing P132, the autonomous driving control apparatus 100 executes a processing for controlling the autonomous driving to perform the operation described in FIG. 3. In the abnormal processing P132, the autonomous driving control apparatus 100 may be configured to detect that any one of the plurality of MaaS vehicles 1 approaches and passes by as the preceding vehicle based on the service information of the other MaaS vehicles.

In the control amount calculation processing P140, the autonomous driving control apparatus 100 executes generating a control signal giving a control amount related to travel control (e.g., acceleration, braking, or steering) based on the processing result of the driving plan generation processing P130. For example, when a traveling route is given as the processing result of the driving plan generation processing P130, the autonomous driving control apparatus generates the control signal controlling the autonomous vehicle to travel along the traveling route. The autonomous driving control apparatus 100 outputs the generated control signal.

### 3. PROCESSING

Hereinafter, processing executed by the server 2 (dispatch management device) and processing executed by each of the autonomous vehicles in the vehicle dispatch system 10 according to the present embodiment will be described.

### 3-1. Dispatch Plan Generation Processing

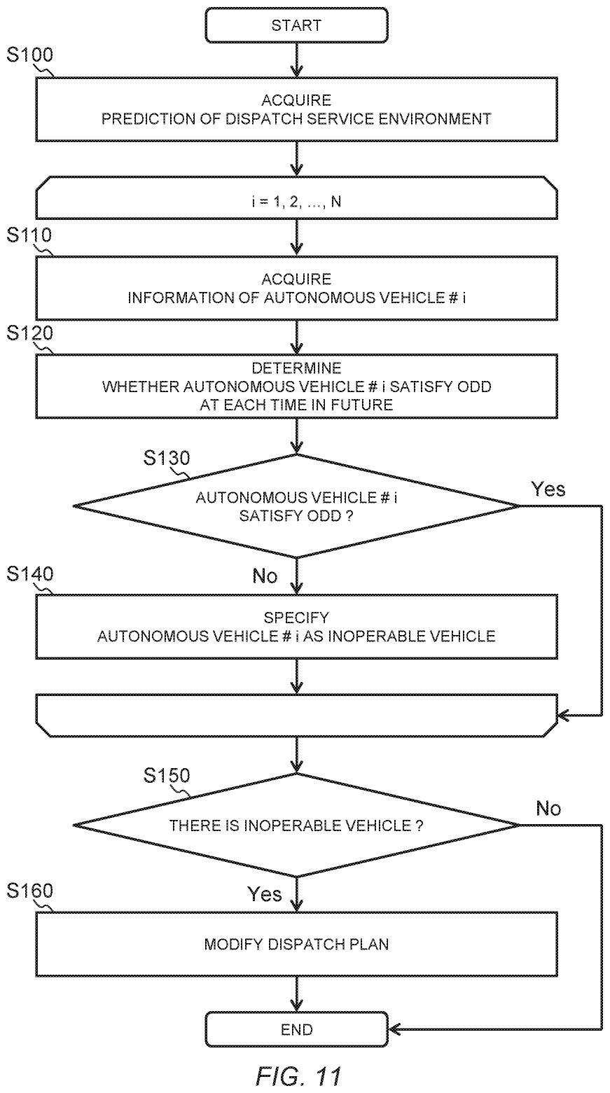

FIG. 11 is a flowchart showing the dispatch plan generation processing executed by the processor 220 in the server 2 (dispatch management device). The processing of the flowchart shown in FIG. 11 is repeatedly executed at predetermined processing intervals.

In step S100, the processor 220 acquires the prediction of dispatch service environment at each time for a predetermined period of time in the future.

After step 100, the processing proceeds to step S110. Here, the processing from step S110 to step S140 is executed for each of the autonomous vehicles (i=1, 2, . . . , N) included in the plurality of MaaS vehicles 1. Where N is the total number of the autonomous vehicles.

In step S110, the processor 220 acquires information (the vehicle information and the service information) of the target autonomous vehicle (#i). In particular, the processor 220 acquires information of the ODD of the target autonomous vehicle.

After step S110, the processing proceeds to step S120.

In step S120, the processor 220 determines whether the target autonomous vehicle satisfies the ODD at each time in the future based on the prediction of dispatch service environment and the ODD of the target autonomous vehicle.

When the ODD is not satisfied (step S130; No), the target autonomous vehicle is specified as the inoperable vehicle (step S140).

After the execution of the processing from step S110 to step S140 is completed for each of the autonomous vehicles (i=1, 2, . . . , N), the processing proceeds to step S1 50.

In step S150, the processor 220 determines whether or not there is an autonomous vehicle specified as the inoperable vehicle by executing the processing of step S110 to step S140.

When there is the inoperable vehicle (step S150; Yes), the processing proceeds to step S160. When there is no autonomous vehicle specified as the inoperable vehicle (step S150; No), the current processing ends without modifying the dispatch plan.

In step S160 (dispatch plan modification processing), the processor 220 modifies the dispatch plan depending on the vehicle information or the service information of the inoperable vehicle. For example, the processor 220 modifies the dispatch plan according to the above-described first example, second example, third example, or a combination thereof.

After step S160, the current processing ends.

In this way, the dispatch plan generation processing is executed by the processor 220 in the server 2 (dispatch management device). And in this way, the vehicle dispatch system 10 according to the present embodiment realizes a vehicle dispatch management method for a plurality of MaaS vehicles 1 being dispatched in accordance with the dispatch plan.

### 3-2. Initial Dispatch Plan

When the server 2 (dispatch management device) first executes the dispatch plan generation processing for a plurality of MaaS vehicles 1, the server 2 first generates the initial dispatch plan as an initial value. Here, the server 2 can generate the initial dispatch plan based on the prediction of dispatch service environment and the vehicle information or the service information of the plurality of MaaS vehicles 1. Hereinafter, a processing for generating the initial dispatch plan will be described.

Now, it is assumed that the plurality of MaaS vehicles 1 include upper grade vehicles which are the autonomous vehicles having high specifications and satisfying the ODD in all the dispatch service area, and lower grade vehicles which are the autonomous vehicles which may not satisfy the ODD depending on the situation of the dispatch service area. Furthermore, the plurality of MaaS vehicles 1 may include the manual driving vehicles. Here, in general, the upper grade vehicles have higher costs, and the lower grade vehicles have lower costs. For this reason, it is desirable to generate the dispatch plan that dispatches the minimum number of the upper grade vehicles. Therefore, in the processing for generating the initial dispatch plan, the server 2 first assigns high priority services to the upper grade vehicles. For example, a service for an urgent transport or an operation of carrying people is assigned to the upper grade vehicles. Then, the server 2 assigns the other services to the lower grade vehicles.

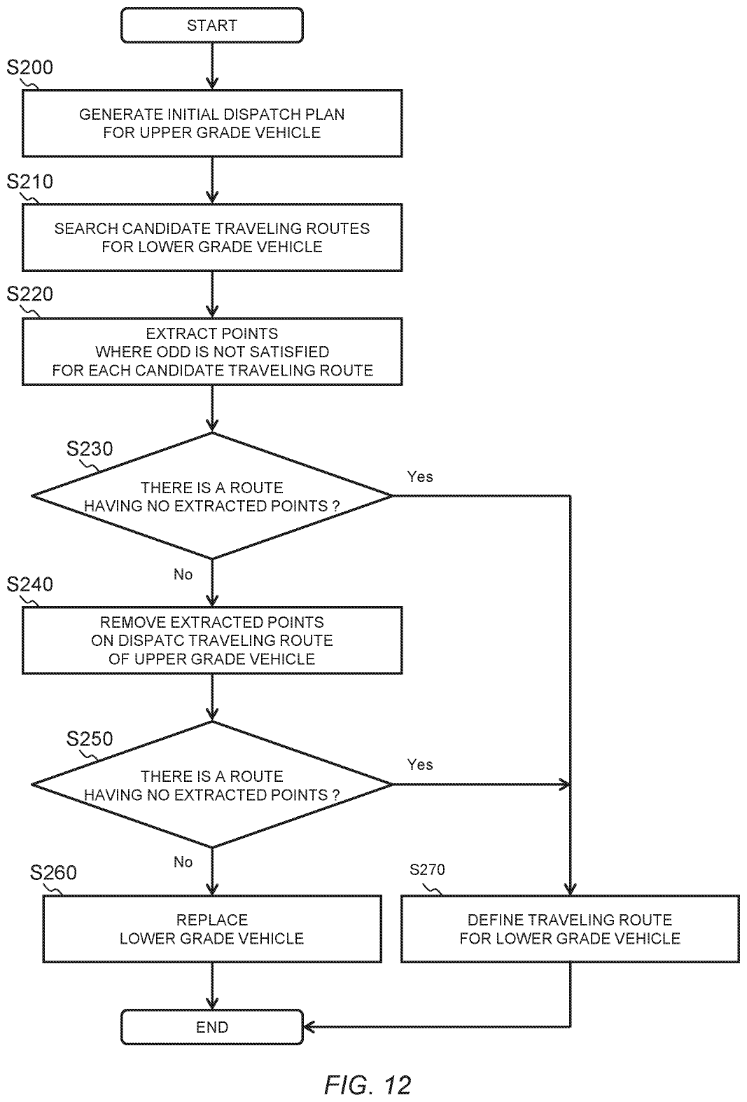

Assuming the above, the processing for generating the initial dispatch plan will be described with reference to FIG. 12. But it is assumed that each of the autonomous vehicles included in the plurality of MaaS vehicles 1 is configured to operate similarly as described in FIG. 3 when the ODD is not satisfied. The processing of the flowchart shown in FIG. 12 is executed by the processor 220 in the server 2 (dispatch management device).

In step S200, the processor 220 generates the initial dispatch plan for the upper grade vehicles.

After step S200, the processing proceeds to step S210.

In step S210, the processor 220 searches candidate traveling routes for the lower grade vehicles based on information regarding the departure point and the destination of the lower grade vehicles and the map information.

After step S210, the processing proceeds to step S220.

In step S220, the processor 220 extracts points where the ODD is not satisfied for each of the candidate traveling routes searched in step S210. Here, the extracted point may include not only a point at which the ODD is not satisfied due to a static factor (e.g., factors given by map information) but also a point at which the ODD is predicted not to be satisfied based on the prediction of dispatch service environment.

After step S220, the processing proceeds to step S230.

In step S230, the processor 220 determines whether or not there is a route having no points extracted in step S210 among the candidate traveling routes searched in step S220.

When there is a route having no the extracted points (step S230; Yes), the processor 220 generates the initial dispatch plan for the lower grade vehicles to define the route having no the extracted points as the dispatch traveling route for the lower grade vehicles (step S270), and the processing ends. Here, when there are two or more routes having no the extracted points, an optimum route such as a route having the shortest traveling distance or the shortest traveling time may be defined as the dispatch traveling route for the lower grade vehicles.

When there is no route having no the extracted points (step S230; No), the processing proceeds to step S240.

In step S240, the processor 220 removes the extracted points existing on the dispatch traveling route of the upper grade vehicles. This is because, when the extracted point exists on the dispatch traveling route of the upper grade vehicles, it is expected that the lower grade vehicle travels following the upper grade vehicle to get out of the extracted point.

After step S240, the processing proceeds to step S250.

In step S250, the processor 220 determines again whether or not there is a route having no the extracted points among the candidate traveling routes searched in step S210.

When there is a route having no the extracted points (step S250; Yes), the processor 220 generates the initial dispatch plan for the lower grade vehicles to define the route having no the extracted points as the dispatch traveling route for the lower grade vehicles (step S270), and the processing ends.

When there is no route having no the extracted points (step S250; No), the processor 220 generates the initial dispatch plan to replace the lower grade vehicles with MaaS vehicles capable of traveling any one route (step S260). For example, the lower grade vehicles are replaced with the upper grade vehicles. Alternatively, the lower grade vehicles are replaced with MaaS vehicles capable of satisfying the ODD depending on the situation predicted to occur. After step S260, the processing ends.

By generating the initial dispatch plan serving as described above, it is possible to provide the dispatch plan in which the prediction of dispatch service environment and the vehicle information or the service information of the plurality of MaaS vehicles 1 are considered. Then, it is thus possible to provide the dispatch plan that dispatches the minimum number of the upper grade vehicles, and to reduce the costs. Furthermore, it is possible to optimize the costs even in the modified dispatch plan thereafter.

The following modification may be applied for the generation of the initial dispatch plan described with reference to FIG. 12.

One is the modification for a case where the lower grade vehicles include two or more autonomous vehicles having different specifications. In this case, in step S220, the processor 220 may extract points where the ODD is not satisfied for each specifications. And, in step S230 or Step S250, the processor 220 may determine whether or not there is a route having no the extracted points for each specifications. Then, in step S230 or step S250, when there is a route having no the extracted points (step S230; Yes or step S250; Yes), the processor 220 may generate the initial dispatch plan to dispatch an autonomous vehicle having a specification with the lowest cost. By applying the modification as described, it is possible to generate the initial dispatch plan at a lower cost.

Another one is the modification for a case where there is no route having no the extracted points in step S250 (step S250; No). In the case, the following processing may be executed instead of the processing related to step S260 or in addition to the processing related to step S260. First, the processor 220 specifies points to be removed from the extracted points. The points to be removed are, for example, points where a route having no the extracted points is expected to exist when the points are removed. Next, the processor 220 selects a upper grade vehicle that can pass through the specified points and that have the lowest cost for passing (required time, presence or absence of passengers, or the like). Here, whether or not the upper grade vehicle pass through the specified points is indicated by, for example, whether or not it is possible to meet a target time when the upper grade vehicle (e.g., a vehicle for an urgent transport) pass through the specified points. Also, for example, it is indicated whether or not the upper grade vehicle (e.g., a vehicle carrying people) can pass through thee specified points in a section without passengers. Then, the processor 220 generates the initial dispatch plan to let the selected upper grade vehicle pass though the specified points. By applying the modification as described, it is possible to reduce the frequency of replacing the lower grade vehicles with the upper grade vehicles. Therefore, it is possible to reduce the cost.

### 3-3. Processing Executed by Autonomous Driving Control Apparatus

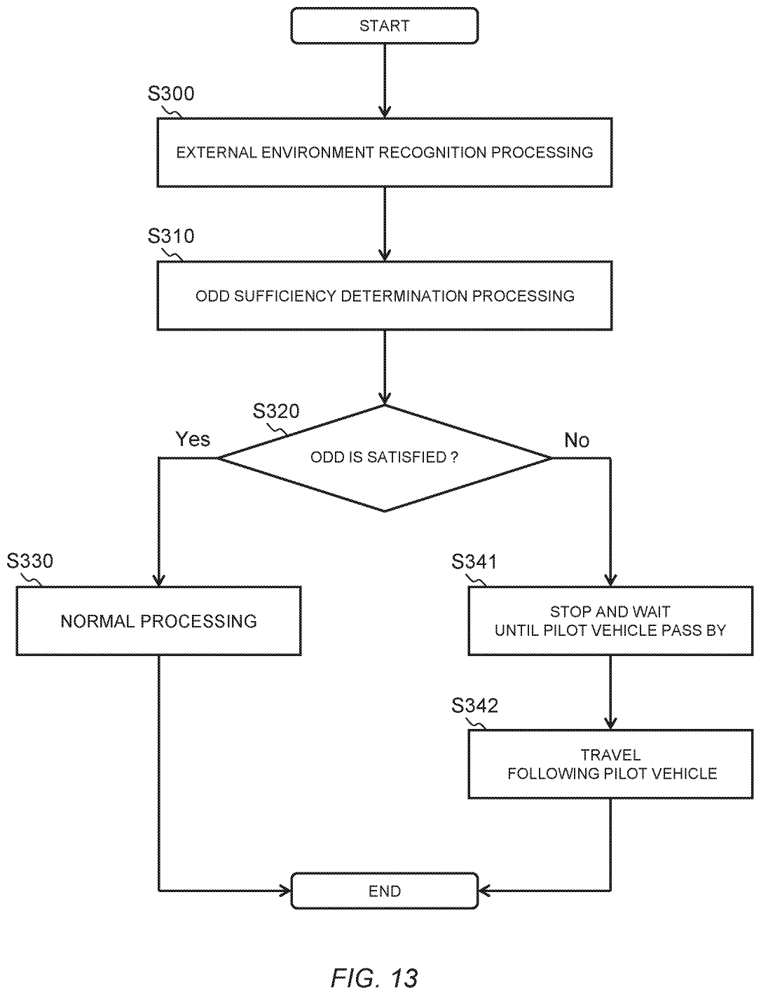

FIG. 13 is a flowchart showing a processing executed by the autonomous driving control apparatus 100 in the autonomous vehicle. The processing of the flowchart shown in FIG. 13 is repeatedly executed at predetermined processing intervals.

In step S300, the autonomous driving control apparatus 100 executes the external environment recognition processing P110.

After step S300, the processing proceeds to step S310.

In step S310, the autonomous driving control apparatus 100 executes the ODD sufficiency determination processing P120.

When the processing result of the ODD sufficiency determination processing P120 shows that the ODD is satisfied (step S320; Yes), the processing proceeds to step S330 (the normal processing P131). When the processing result of the ODD sufficiency determination processing P120 shows that the ODD is not satisfied ODD (step S320; No), the processing proceeds to step S341 and step S342 (the abnormal processing P132).

In step S330, the autonomous driving control apparatus 100 generates a driving plan to continue autonomous driving in accordance with the dispatch plan based on the processing result of the external environment recognition processing P110.

In step S341, the autonomous driving control apparatus 100 controls the autonomous vehicle to make a stop safely. After the stop, the autonomous vehicle waits until the pilot vehicle passes.

Then, in response to the pilot vehicle passing, the autonomous driving control apparatus 100 controls the autonomous vehicle to travel following the pilot vehicle (step S342). When the ODD is satisfied while traveling following the pilot vehicle (step S320; Yes), the autonomous driving control apparatus 100 resumes the autonomous driving by executes the normal processing P131 processing related to step S330 is executed, and the autonomous driving is resumed.

### 4. EFFECT

As described above, according to the present embodiment, the inoperable vehicle in the dispatch plan currently generated is specified based on the ODD and the prediction of dispatch service environment of the autonomous vehicles included in the plurality of MaaS vehicles 1. Then, the dispatch plan is modified depending on the vehicle information or the service information of the inoperable vehicle. As a result, it is possible to deal with the inoperable vehicle predicted not to satisfy the ODD while a predetermined period of time in the future in the current dispatch plan, and it is possible to reduce the frequency of recovering and the time and effort required for recovery. As a result, it is possible to reduce the operation cost.

The vehicle dispatch system 10 according to the present embodiment may be configured to generate and modify the dispatch plan for only the one or more pilot vehicles guiding the inoperable vehicles, referring to the first example of modifying the dispatch plan. That is, in this case, vehicles dispatched by the vehicle dispatch system 10 are only the one or more pilot vehicles. And the inoperable vehicles may not be vehicles dispatched by the vehicle dispatch system 10. In particular, the inoperable vehicles may not be limited to vehicles (e.g., bus, taxi, or the like) performing a predetermined operation, but may be vehicles bound for any destination. However, as described above, the server 2 needs to be configured to acquire the vehicle information (including information of the ODD) and the service information of the inoperable vehicles. When configuring the vehicle dispatch system 10 described above, the server 2 can also be referred to as a “pilot planning apparatus”.

What is claimed is:

1. A system comprising:
a plurality of MaaS vehicles;
one or more processors; and
a memory storing executable instructions that, when executed by the one or more processors, cause the one or more processors to execute generating a dispatch plan for the plurality of MaaS vehicles,
wherein the plurality of MaaS vehicles includes one or more autonomous vehicles performing autonomous driving in accordance with the dispatch plan, and
the generating the dispatch plan includes:
acquiring an operational design domain of the one or more autonomous vehicles;
acquiring a prediction of dispatch service environment for a predetermined period of time in the future regarding a dispatch service area of the one or more autonomous vehicles;
specifying an inoperable vehicle among the one or more autonomous vehicles based on the operational design domain and the prediction of dispatch service environment, the inoperable vehicle being an autonomous vehicle that is predicted not to satisfy the operational design domain in the dispatch plan currently generated; and
modifying the dispatch plan depending on vehicle information or service information of the inoperable vehicle.

2. The system according to claim 1,
wherein each of the one or more autonomous vehicles is configured to:
make a stop when the operational design domain is not satisfied;
travel following a preceding vehicle, the preceding vehicle being any one of the plurality of MaaS vehicles passing by the each of the one or more autonomous vehicles after the stop; and
resume the autonomous driving when the operational design domain is satisfied while traveling following the preceding vehicle.

3. The system according to claim 2,
wherein the modifying the dispatch plan includes modifying the dispatch plan to let one or more pilot vehicles, as the preceding vehicle, pass through a point where it is predicted that the inoperable vehicle does not satisfy the operational design domain, the one or more pilot vehicles being selected among the plurality of MaaS vehicles.

4. The system according to claim 3,
wherein each of the one or more pilot vehicles is an autonomous vehicle satisfying the operational design domain in the dispatch plan after modifying or a vehicle driven by a driver.

5. The system according to claim 1,
wherein the modifying the dispatch plan includes modifying the dispatch plan to replace the inoperable vehicle before dispatch with an autonomous vehicle satisfying the operational design domain in the dispatch plan or a vehicle driven by a driver.

6. The system according to claim 2,
wherein the modifying the dispatch plan includes, when there is a set of specified inoperable vehicles before dispatch predicted not to satisfy the operational design domain at the same point, modifying the dispatch plan to replace at least one of the specified inoperable vehicles before dispatch with an autonomous vehicle satisfying the operational design domain in the dispatch plan or a vehicle driven by a driver.

7. A method for managing dispatch service of a plurality of MaaS vehicles being dispatched in accordance with a dispatch plan, the plurality of MaaS vehicles including one or more autonomous vehicles performing autonomous driving in accordance with the dispatch plan, the method comprising:
acquiring an operational design domain of the one or more autonomous vehicles;
acquiring a prediction of dispatch service environment for a predetermined period of time in the future regarding a dispatch service area of the one or more autonomous vehicles;
specifying an inoperable vehicle among the one or more autonomous vehicles based on the operational design domain and the prediction of dispatch service environment, the inoperable vehicle being an autonomous vehicle that is predicted not to satisfy the operational design domain in the dispatch plan currently generated; and
modifying the dispatch plan depending on vehicle information or service information of the inoperable vehicle.

8. The method according to claim 7,
wherein each of the one or more autonomous vehicles is configured to:
make a stop when the operational design domain is not satisfied;
travel following a preceding vehicle, the preceding vehicle being any one of the plurality of MaaS vehicles passing by the each of the one or more autonomous vehicles after the stop; and
resume the autonomous driving when the operational design domain is satisfied while traveling following the preceding vehicle, and
the modifying the dispatch plan includes modifying the dispatch plan to let one or more pilot vehicles, as the preceding vehicle, pass through a point where it is predicted that the inoperable vehicle does not satisfy the operational design domain, the one or more pilot vehicles being selected among the plurality of MaaS vehicles.

9. The method according to claim 7,
wherein the modifying the dispatch plan includes modifying the dispatch plan to replace the inoperable vehicle before dispatch with an autonomous vehicle satisfying the operational design domain in the dispatch plan or a vehicle driven by a driver.

10. The method according to claim 7,
wherein each of the one or more autonomous vehicles is configured to:
make a stop when the operational design domain is not satisfied;
travel following a preceding vehicle, the preceding vehicle being any one of the plurality of MaaS vehicles passing by the each of the one or more autonomous vehicles after the stop; and
resume the autonomous driving when the operational design domain is satisfied while traveling following the preceding vehicle, and
the modifying the dispatch plan includes, when there is a set of specified inoperable vehicles before dispatch predicted not to satisfy the operational design domain at the same point, modifying the dispatch plan to replace at least one of the specified inoperable vehicles before dispatch with an autonomous vehicle satisfying the operational design domain in the dispatch plan or a vehicle driven by a driver.
